(19) United States
(12) Patent Application Publication
(10) Pub. No.: US 2026/0063851 A1
(43) Pub. Date: Mar. 5, 2026

(54) OPTICAL PASSIVE ASSEMBLY AND OPTICAL MODULE INCLUDING ELASTOMER AND ADAPTER

(71) Applicant: Global Technology Inc., Ningbo (CN)

(72) Inventors: Xin ZHANG, Ningbo (CN); Qilin HONG, Ningbo (CN); Kejun CHEN, Ningbo (CN); YongZu LONG, Ningbo (CN)

(21) Appl. No.: 18/944,541

(22) Filed: Nov. 12, 2024

(30) Foreign Application Priority Data
Sep. 2, 2024 (CN) 202411223093.4

(51) Int. Cl. G02B 6/38

(52) U.S. Cl. CPC G02B 6/3825; G02B 6/3858; G02B 6/3885

(57) ABSTRACT

The present disclosure provides an optical module, including a housing, an adapter, an optical connector, and an elastomer. The adapter is coupled to the housing. The optical connector is received in the adapter. The elastomer is coupled to the adapter. The housing compresses the elastomer. In one embodiment, an optical module includes a plurality of adapters, optical connectors, or elastomers.

### CROSS-REFERENCE TO RELATED APPLICATIONS

This non-provisional application claims priority under 35 U.S.C. § 119(a) on Patent Application No(s). 202411223093.4 filed in China on Sep. 2, 2024, the entire contents of which are hereby incorporated by reference.

### BACKGROUND

### Technical Field

The present disclosure relates to an optical module and an optical passive assembly.

### Related Art

Optical modules can transmit and/or receive optical signals for various applications including, but not limited to, internet data center, Cable TV, and fiber to the home (FTTH). Using optical modules for transmission can provide higher transmission rates and signal bandwidth over longer transmission distances. In order to enhance the compatibility of optical internetworking products all over the world and to reduce the burden of maintenance, organizations such as Multi-Source Agreement (MSA), Institute of Electrical and Electronic Engineers (IEEE), and Optical Internetworking Forum (OIF) have developed several form factors adapted to different signal transmission rates. These form factors include, but not limited to, XFP, SFP, QSFP (Quad Small Form Factor Pluggable), QSFP-DD (Double Density), OSFP (Octal Small Form Factor Pluggable), and CPO (Co-Packaged Optics).

However, conventional optical modules still present some problems, such as optical power, space management, thermal management, insertion loss, and manufacturing yield.

### SUMMARY

According to one embodiment of the present disclosure, an optical module includes a housing, an adapter, an optical connector, and an elastomer. The adapter is coupled to the housing. The optical connector is received in the adapter. The elastomer is coupled to the adapter, and the housing compresses the elastomer.

According to another embodiment of the present disclosure, an optical module includes a housing, a plurality of adapters, a plurality of optical connectors, and a plurality of elastomers. The adapters are coupled to the housing. The optical connectors are received in the adapters, respectively. The elastomers are coupled to the adapters, respectively. The housing compresses the elastomer along a first direction of the optical module. The adapters are arranged in a second direction of the optical module. The first direction is substantially perpendicular to the second direction.

According to still another embodiment of the present disclosure, an optical passive assembly includes an adapter, a multi-fiber connector, and an elastomer. The multi-fiber connector is received in the adapter. The elastomer includes a first elastic member and a second elastic member that are separated from each other. The adapter has two recesses that are disposed opposite to each other. The first elastic member and the second elastic member are disposed in the two recesses, respectively. Each of the first elastic member and the second elastic member includes at least one extending portion, and the extending portion extends out of respective recess.

### BRIEF DESCRIPTION OF THE DRAWINGS

The present disclosure will become better understood from the detailed description given hereinbelow and the accompanying drawings which are given by way of illustration only and thus are not intended to limit the present disclosure and wherein:

FIG. 1 is a perspective view of an optical passive assembly according to one embodiment of the present disclosure.

FIG. 2 is an exploded view of the optical passive assembly in FIG. 1.

FIG. 3 is a perspective view of an optical passive assembly according to another embodiment of the present disclosure.

FIG. 4 is a perspective view of an optical passive assembly according to still another embodiment of the present disclosure.

FIG. 5 is a perspective view of an optical passive assembly according to yet another embodiment of the present disclosure.

FIG. 6 is an exploded view of an optical module according to one embodiment of the present disclosure.

FIG. 7 is a front view of the optical module in FIG. 6.

FIG. 8 is a schematic view showing an assembly process of the optical module in FIG. 7.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

An optical module includes a housing and an adapter that receives an optical connector, and the adapter is coupled to the housing. During an assembly process of the adapter and the housing, the adapter and the housing may be moved relative to each other due to manufacturing tolerance. When an operator is plugging and/or unplugging optical cables, the movement between the adapter and the housing may adversely affect a stability of signal transmission.

According to one embodiment of the present disclosure, an optical passive assembly includes an elastomer that is coupled to an adapter, and a housing of an optical module compresses the elastomer. The elastomer deformed due to stress applied by the housing can be disposed in a gap between the adapter and the housing, thereby compensate the tolerance between the adapter and the housing, such that the adapter and the housing can be stationary relative to each other.

Some or all of the technical features disclosed in one or more embodiments of the present disclosure may be combined to achieve corresponding effects.

The term “couple” or “coupled to” refers to any connection, link, or the like. Moreover, the term “optically couple” or “optically coupled to” refers to a relationship where light is transmitted (imparted) from a device to another. Unless otherwise specified, devices that “couple” or “coupled to” each other do not need to be directly connected to each other and may be separated by intervening objects.

The term substantially, as generally referred to herein, refers to a degree of precision within acceptable tolerance that accounts for and reflects minor real-world variation due to material composition, material defects, and/or limitations/peculiarities in manufacturing processes. Such variation may therefore be said to achieve largely, but not necessarily wholly, the stated characteristic.

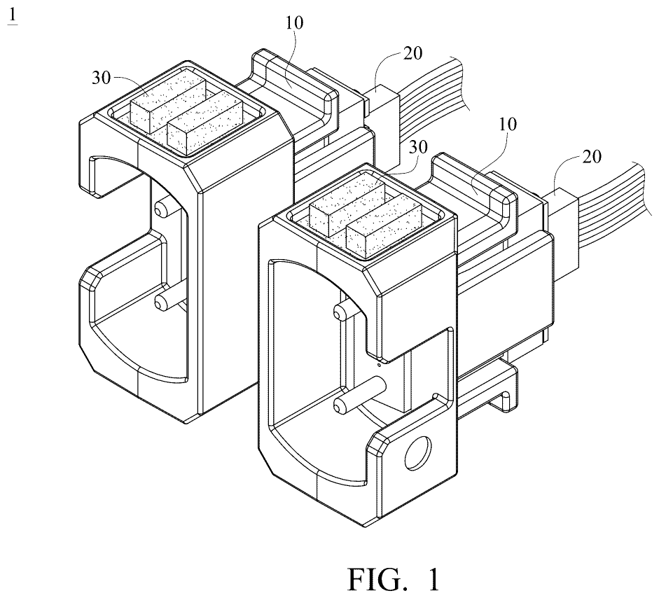

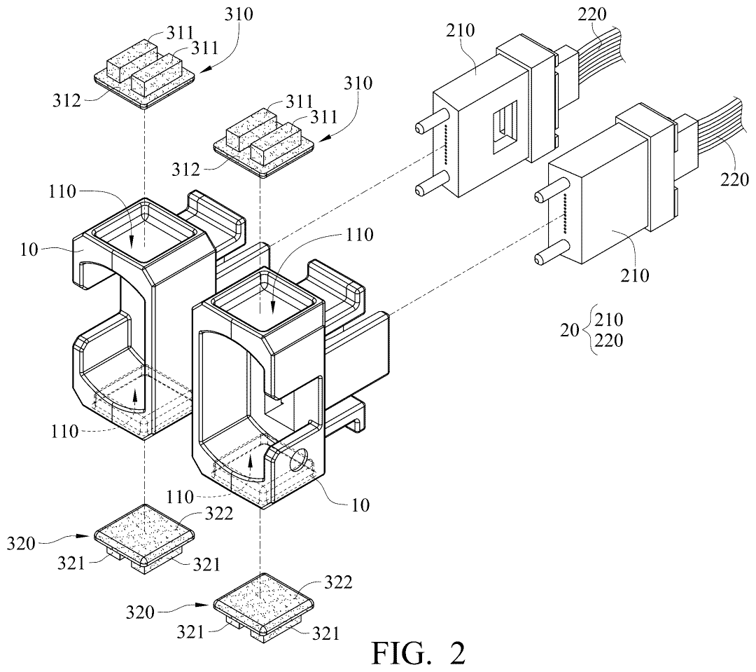

FIG. 1 is a perspective view of an optical passive assembly 1 according to one embodiment of the present disclosure, and FIG. 2 is an exploded view of the optical passive assembly 1 in FIG. 1. According to an embodiment, the optical passive assembly 1 may include an adapter 10, an optical connector 20, and an elastomer 30.

In one embodiment, the adapter 10 complies with International Electrotechnical Commission (IEC) standards. In one embodiment, the adapter 10 is made of an elastic material. In one embodiment, the adapter 10 is a plastic receptacle. In one embodiment, referring to FIG. 1, the optical passive assembly 1 includes a plurality of adapters 10.

In one embodiment, the optical connector 20 may be a multi-fiber connector. In one embodiment, the optical connector 20 may include a main body 210 and multiple optical fibers 220 that are coupled to the main body 210. In one embodiment, the optical fibers 220 may extend through a corresponding main body 210. In one embodiment, the optical connector 20 may be an MPO connector. In one embodiment, referring to FIG. 2, the optical connector 20 may be an MPO male connector. In one embodiment, referring to FIG. 2, the optical passive assembly 1 may include a plurality of optical connectors 20.

In one embodiment, the elastomer 30 may be deformed by an external force applied thereon, and the elastomer 30 may restore to its initial state when the external force is removed. In one embodiment, the elastomer 30 may be made of rubber. In one embodiment, the elastomer 30 may be a component including one or more rubber and one or more spring.

According to an embodiment, the optical connector 20 may be received in the adapter 10. In one embodiment, the adapter 10 is sleeved on the optical connector 20. In one embodiment, referring to FIG. 2, a plurality of optical connectors 20 are received in a plurality of adapters 10, respectively.

According to an embodiment, the elastomer 30 may be coupled to the adapter 10. In one embodiment, a plurality of elastomers 30 may be coupled to a plurality of adapters 10, respectively. In one embodiment, referring to FIG. 1, the elastomer 30 is adhered to an outer surface of the adapter 10.

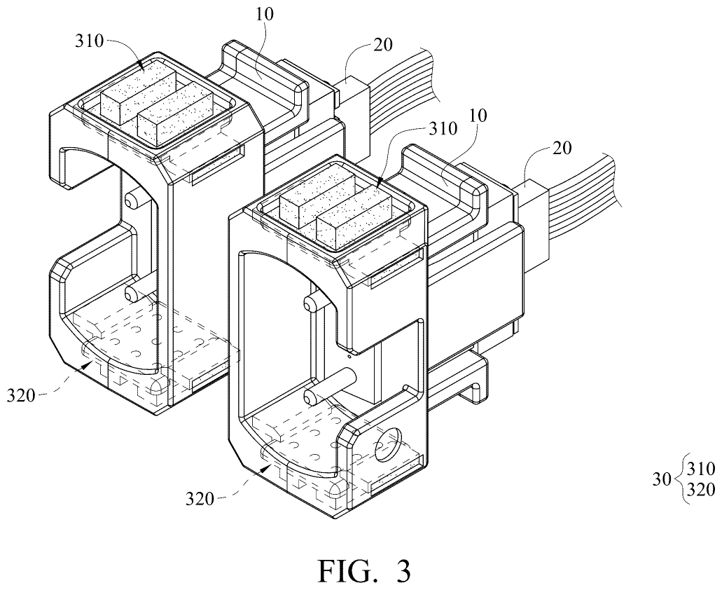

In one embodiment, the adapter 10 covers a part of the elastomer 30. FIG. 3 is a perspective view of an optical passive assembly 1 according to another embodiment of the present disclosure. In this embodiment, a part of the elastomer 30 is buried in the adapter 10, and another part of the elastomer 30 is exposed to the outside. The elastomer 30 that is embedded in the adapter 10 as shown in FIG. 3 may be made by injection molding. However, the present disclosure is not limited to the manufacturing methods listed here.

According to an embodiment, the elastomer 30 may include a first elastic member 310 and a second elastic member 320 that are separated from each other. In one embodiment, the first elastic member 310 and the second elastic member 320 are disposed at opposite sides of the elastomer 30, respectively. In one embodiment, the elastomer 30 is adhered to the outer surface of the adapter 10. In one embodiment, referring to FIG. 1, the first elastic member 310 and the second elastic member 320 are both adhered to the outer surface of the adapter 10. In one embodiment, each of the first elastic member 310 and the second elastic member 320 is a single object made of a rubber.

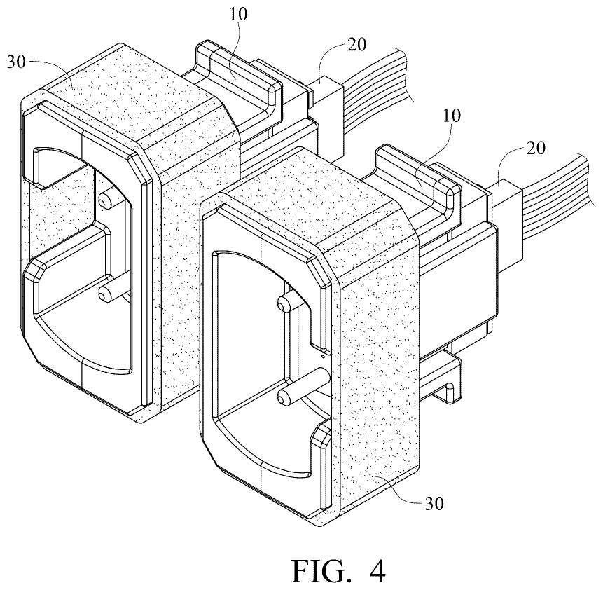

In one embodiment, the elastomer 30 surrounds the outer surface of the adapter 10. FIG. 4 is a perspective view of an optical passive assembly 1 according to still another embodiment of the present disclosure. The elastomer 30 is a single element, and the elastomer 30 is peripherally adhered to the outer surface of the adapter 10.

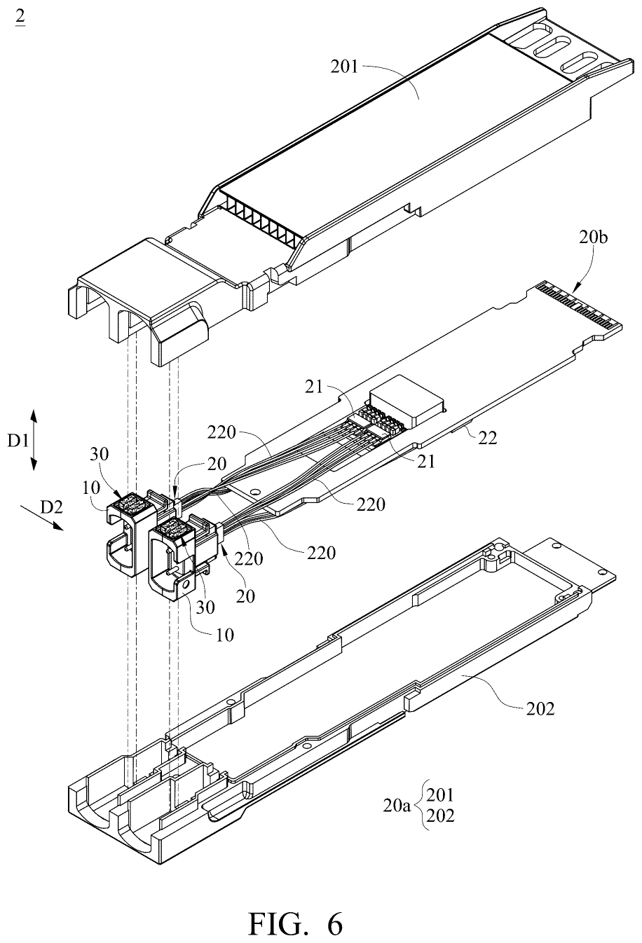

According to an embodiment, the adapter 10 may have two recesses 110 that are opposite to each other, and the recesses 110 may be formed on the outer surface of the adapter 10. In one embodiment, referring to FIG. 2, the first elastic member 310 and the second elastic member 320 of each elastomer 30 are disposed in the two recesses 110 of the corresponding adapter 10, respectively. In one embodiment, referring to FIG. 2, the first elastic member 310 of each elastomer 30 includes at least one extending portion 311, and the extending portion 311 extends out of the corresponding recess 110. In one embodiment, referring to FIG. 2, the second elastic member 320 of each elastomer 30 includes at least one extending portion 321, and the extending portion 321 extends out of the corresponding recess 110. In one embodiment, any one of the first elastic members 310 includes a plurality of extending portions 311. In one embodiment, any one of the second elastic members 320 includes a plurality of extending portions 321. Because the adapter 10 has the recess 110 for accommodating the elastomer 30, the elastomer 30 is allowed to have a larger overall thickness. For example, the elastomer 30 is allowed to have a longer extending portion 311 in a vertical direction of the adapter 10, which is helpful to prolong a lifespan of the elastomer 30. The aforesaid vertical direction of the adapter 10 may be understood as a first direction D1 shown in FIG. 6.

According to an embodiment, the elastomer 30 may include a mounting portion and at least one extending portion. In one embodiment, the first elastic member 310 of the elastomer 30 includes a mounting portion 312 and an extending portion 311. The mounting portion 312 is disposed in the corresponding recess 110. The extending portion 311 is seated on the mounting portion 312 and extends out of the recess 110. In one embodiment, the second elastic member 320 of the elastomer 30 includes a mounting portion 322 and an extending portion 321. The mounting portion 322 is disposed in the corresponding recess 110. The extending portion 321 is seated on the mounting portion 322 and extends out of the recess 110. In one embodiment, as to any one of the first elastic members 310, the extending portions 311 are coupled to the mounting portion 312 and spaced apart from one another. In one embodiment, as to any one of the second elastic members 320, the extending portions 321 are coupled to the mounting portion 322 and spaced apart from one another.

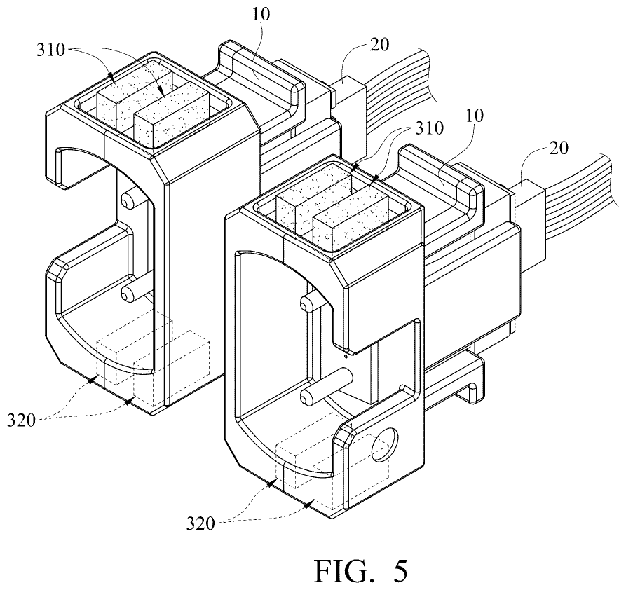

In one embodiment, the extending portion 311 of any one of the first elastic members 310 is adhered to the outer surface of the adapter 10 directly. In one embodiment, the extending portion 321 of any one of the second elastic members 320 is adhered to the outer surface of the adapter 10 directly. FIG. 5 is a perspective view of an optical passive assembly 1 according to yet another embodiment of the present disclosure. In this embodiment, the first elastic member 310 and the second elastic member 320 do not include a mounting portion.

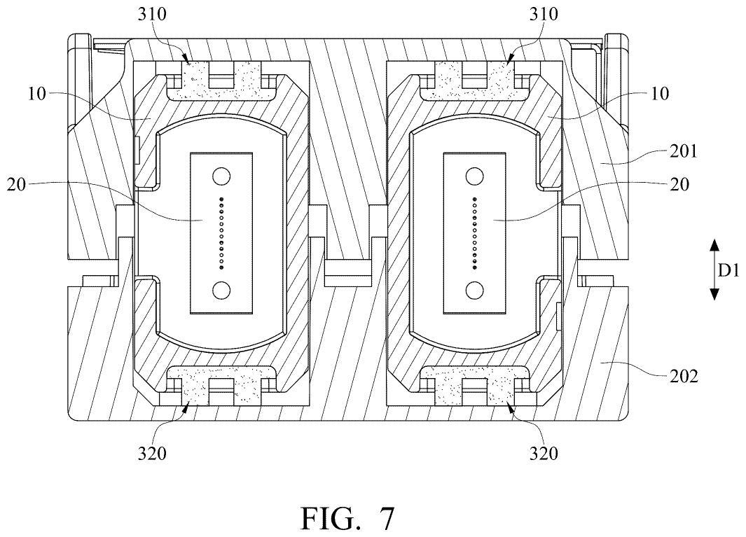

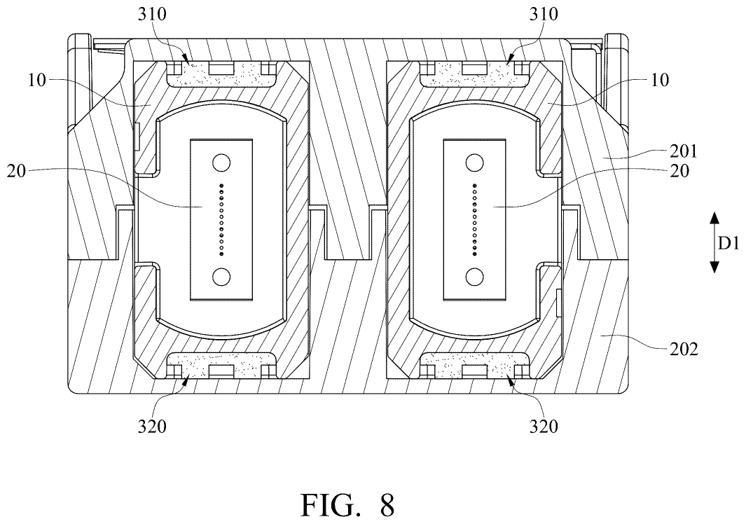

FIG. 6 is an exploded view of an optical module 2 according to one embodiment of the present disclosure, FIG. 7 is a front view of the optical module 2 in FIG. 6, and FIG. 8 is a schematic view showing an assembly of the optical module 2 in FIG. 7. According to an embodiment, the optical module 2 may include a housing 20a and an optical passive assembly 20b. The optical passive assembly 20b may be the aforesaid optical passive assembly 1 in FIG. 1, or may be an optical transferring assembly of any other embodiments.

In one embodiment, the optical module 2 is an optical transceiver including an optical subassembly (TOSA) 21 and a receiver optical subassembly (ROSA) 22. The optical connector 20 of the optical passive assembly 20b is optically coupled to the TOSA 21 or the ROSA 22 through the optical fibers 220. In one embodiment, the TOSA 21 includes a laser diode, and optionally includes a focusing lens, an optical isolator and/or a wavelength multiplexer. In one embodiment, the ROSA 22 includes a photodiode, and optionally includes a fiber array, a wavelength demultiplexer and/or a reflecting mirror.

The optical passive assembly 20b is accommodated in the housing 20a. In one embodiment, the housing 20a is a single piece. In one embodiment, the housing 20a includes an upper housing part 201 and a lower housing part 202. In one embodiment, referring to FIG. 6, the housing 20a is a multi-part housing including the upper housing part 201 and the lower housing part 202. The upper housing part 201 and the lower housing part 202 are assembled to each other to accommodate the optical passive assembly 20b.

According to an embodiment, the adapter 10 of the optical passive assembly 20b may be coupled to the housing 20a. In one embodiment, the adapter 10 forms a tight fit with the housing 20a. In one embodiment, referring to FIG. 6, the adapter 10 is disposed between the upper housing part 201 and the lower housing part 202.

According to an embodiment, the housing 20a may compress the elastomer 30 of the optical passive assembly 20b. In one embodiment, the upper housing part 201 and the lower housing part 202 are assembled to each other along the first direction D1 (which may be understood as an assembly direction here) of the optical module 1. An inner surface of the upper housing part 201 or the lower housing part 202 compresses the elastomer 30. In one embodiment, referring to FIGS. 7 and 8, the first elastic member 310 and the second elastic member 320 of the elastomer 30 are coupled to opposite sides of the adapter 10, respectively. The inner surface of the upper housing part 201 compresses the first elastic member 310 along the first direction D1. The inner surface of the lower housing part 202 compresses the second elastic member 320 along the first direction D1. A deformation of the compressed first elastic member 310 and a deformation of the compressed second elastic member 320 are not shown in FIG. 8.

According to an embodiment, the adapters 10 of the optical module 2 are arranged in a second direction D2. The housing 20a compresses the elastomer 30 along the first direction D1 of the optical module 2. The first direction D1 is substantially perpendicular to the second direction D2. In one embodiment, referring to FIG. 7, the upper housing part 201 applies stress downward along the first direction D1 to compresses the first elastic member 310, and the lower housing part 202 applies stress upward along the first direction D1 to compresses the second elastic member 320.

According to an embodiment, a part of the adapter 10 may be in direct contact with the housing 20a. In one embodiment, a part of each of the adapters is in direct contact with the housing 20a. In one embodiment, referring to FIG. 6, the adapter 10 is in direct contact with the housing 20a in the second direction D2.

According to an embodiment, the elastomer 30 may be in direct contact with an inner surface of the housing 20a. In one embodiment, each elastomer 30 is in direct contact with the inner surface of the housing 20a. In one embodiment, the first elastic member 310 is in direct contact with the inner surface of the upper housing part 201. In one embodiment, the second elastic member 320 is in direct contact with the inner surface of the lower housing part 202.

According to the present disclosure, the elastomer deformed due to stress applied by the housing can be disposed in a gap between the adapter and the housing, thereby compensate the tolerance between the adapter and the housing, such that the adapter and the housing can be stationary relative to each other.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An optical module, comprising:
a housing;
an adapter, coupled to the housing;
an optical connector, received in the adapter; and
an elastomer, coupled to the adapter, wherein the housing compresses the elastomer.

2. The optical module according to claim 1, wherein the housing comprises an upper housing part and a lower housing part that are assembled to each other, and an inner surface of the upper housing part or an inner surface of the lower housing part compresses the elastomer.

3. The optical module according to claim 2, wherein the elastomer comprises a first elastic member and a second elastic member that are separated from each other, the upper housing part and the lower housing part are assembled to each other along an assembly direction, the first elastic member and the second elastic member are coupled to opposite sides of the adapter, respectively, the inner surface of the upper housing part compresses the first elastic member along the assembly direction, and the inner surface of the lower housing part compresses the second elastic member along the assembly direction.

4. The optical module according to claim 3, wherein the adapter is in direct contact with the housing.

5. The optical module according to claim 1, wherein the elastomer is in direct contact with an inner surface of the housing.

6. The optical module according to claim 1, wherein the elastomer is adhered to an outer surface of the adapter.

7. The optical module according to claim 1, wherein the adapter covers a part of the elastomer.

8. The optical module according to claim 1, wherein the adapter has a recess, the elastomer comprises a mounting portion and at least one extending portion, the mounting portion is disposed in the recess, the at least one extending portion extends out of the recess, and the housing compresses the at least one extending portion.

9. The optical module according to claim 8, wherein the at least one extending portion comprises a plurality of extending portions, and the plurality of extending portions are coupled to the mounting portion and are spaced apart from one another.

10. The optical module according to claim 1, wherein the optical connector is a multi-fiber connector.

11. An optical module, comprising:
a housing;
a plurality of adapters, coupled to the housing;
a plurality of optical connectors, received in the plurality of adapters, respectively; and
a plurality of elastomers, coupled to the plurality of adapters, respectively;
wherein, the housing compresses the plurality of elastomers along a first direction of the optical module, the plurality of adapters are arranged in a second direction of the optical module, and the first direction is substantially perpendicular to the second direction.

12. The optical module according to claim 11, wherein the housing comprises an upper housing part and a lower housing part that are assembled to each other, and an inner surface of the upper housing part or an inner surface of the lower housing part compresses the plurality of elastomers.

13. The optical module according to claim 12, wherein each of the plurality of elastomers comprises a first elastic member and a second elastic member that are separated from each other, the upper housing part and the lower housing part are assembled to each other along the first direction, the first elastic member and the second elastic member are coupled to opposite sides of one of the plurality of adapters, respectively, the inner surface of the upper housing part compresses the first elastic member along the assembly direction, and the inner surface of the lower housing part compresses the second elastic member along the assembly direction.

14. The optical module according to claim 13, wherein each of the plurality of adapters is in direct contact with the housing.

15. The optical module according to claim 11, wherein the plurality of elastomers are in direct contact with an inner surface of the housing.

16. The optical module according to claim 11, wherein the plurality of elastomers are adhered to an outer surface of the plurality of adapters, respectively.

17. The optical module according to claim 11, wherein the plurality of adapters cover a part of the plurality of elastomers, respectively.

18. An optical passive assembly, comprising:
an adapter;
a multi-fiber connector, received in the adapter; and
an elastomer, comprising a first elastic member and a second elastic member separated from each other;
wherein, the adapter has two recesses that are disposed opposite to each other, the first elastic member and the second elastic member are disposed in the two recesses, respectively, each of the first elastic member and the second elastic member comprises at least one extending portion, and the at least one extending portion extends out of a corresponding one of the two recesses.
